(19) United States
(12) Patent Application Publication
(10) Pub. No.: US 2007/0042501 A1
(43) Pub. Date: Feb. 22, 2007

(54) A novel technology for the purity assay of TRODAT-1 raw material

(75) Inventors: Kung Tien Liu, Lungtan, Taoyuan (TW); Yi Chih Hsia, Lungtan, Taoyuan (TW); Chung Yung Su, Lungtan, Taoyuan (TW); Chiung Fang Huang, Lungtan, Taoyuan (TW); Ying Kai Fu, Lungtan, Taoyuan (TW)

Correspondence Address: MICHAEL LIN, 5F 79 Roosevelt Rd. Sec. 2, TAIPEI, 106, TW

(73) Assignee: INSTITUTE OF NUCLEAR ENERGY RESEARCH, Lungtan, Taoyuan (TW)

(21) Appl. No.: 11/161,883

(22) Filed: Aug. 20, 2005

(51) Int. Cl. G01N 30/02

(52) U.S. Cl. 436/177; 436/161

(57) ABSTRACT

This invention discloses a novel technology for the purity assay of TRODAT-1 raw material by reverse phase high performance liquid chromatography (RP-HPLC). The method for TRODAT-1 raw material purity assay of this present invention includes using high performance liquid chromatography (HPLC), liquid chromatography tandem mass spectrometry (LC-MS/MS), HPLC column, preparation of samples, regents and eluent as well as performing parent and product ion analysis by mass spectrometry for the method validation, calculation of chromatographic resolutions and raw material purity. This invention discloses the first in the world of purity assay for TRODAT-1 raw material through elaborated validation procedures.

### FIELD OF THE INVENTION

The present invention relates to an analytical technology developed by using the reverse phase high performance liquid chromatography (RP-HPLC) and liquid chromatography tandem mass spectrometry (LC-MS/MS). It is devised for method development and validation of raw material purity assay for TRODAT-1 (ethanethiol,2-[[2-[[[3-(4-chlorophenyl)-8-methyl-8-azabicyclo [3,2,1]oct-2-yl]methyl](2-mercaptoethyl)amino]ethyl]amino],[1R-(exo-exo)]-,hydrochloride).

### BACKGROUND OF THE INVENTION

Technetium-99m-TRODAT-1 is a diagnostic imaging agent specifically binding to dopamine transporter in the basal ganglia region of the brain. TRODAT-1 is the unlabelled precursor of ^{99m}Tc-TRODAT-1. At present, extensively using TRODAT-1 raw material for research and development are mainly focus in the laboratories such as: Hospital of the University of Pennsylvania, USA (J. Nucl. Med. 2000 April; 41 (4) 584-9), Institute of Nuclear Energy Research, Taiwan (J. Nucl. Med. 2001 March; 42 (3) 408-13), National Laboratory of Nuclear Medicine, China (Nucl. Med. Biol. 2000 January; 27 (1) 69-75), Leuven University Hospital and Katholieke Universiteit Leuven, Belgium (Eur. J. Nucl. Med. Mol. Imaging. 2004 August; 31 (8) 1119-27), University of Munich, Germany (Eur. J. Nucl. Med. 2000 October; 27 (10) 1518-24), and Institute of Syncor Corporation (J Zhejiang Univ Sci. 2005 January; 6 (1) 22-7). However, in all literatures published already, reports related to evaluation of TRODAT-1 raw material purity and impurities have not yet become available. Moreover, up to the present, no official purity assay method is specified in the United States Pharmacopeia (USP), European Pharmacopoeia (EP), and British Pharmacopoeia (BP). Therefore, proposal of this method is the first invention in the world that has completed the validation procedures for the purity assay of TRODAT-1 raw material.

### SUMMARY OF THE INVENTION

The present invention discloses an analytical method for the purity assay of TRODAT-1 raw material by reverse phase high performance liquid chromatography (RP-HPLC), as well as validation of the method by liquid chromatography tandem mass spectrometry (LC-MS/MS).

The methodologies for the determination of purity in TRODAT-1 raw material include instrumental facilities, reagents, sample preparations, chromatographic conditions, and calculation formulae. They are elaborated respectively as below:

(1) Instrumentation and Reagents

a. The high performance liquid chromatography (HPLC) consisted of a HPLC pump, a vacuum degasser, an injector, an autosampler, a thermostated column compartment, and a variable wavelength detector (VWD) or a photo-diode array detector (DAD).

b. Liquid chromatography—tandem mass spectrometer (LC-MS/MS).

c. HPLC C-18 reversed phase column.

d. Methanol (MeOH) and trifluoroacetic acid (TFA).

(2) Preparation of Standards, Samples and Eluent:

a. Preparation of standards and samples: All standards and samples were prepared in

HPLC exclusive sample vial, by dissolving 4-5 mg of TRODAT-1 in 1 mL of HPLC grade methanol.

b. Preparation of HPLC eluent [0.1% TFA/MeOH—H₂O (50:50, v/v)]: 500 mL of HPLC grade MeOH was mixed evenly with 500 mL of deionized water, 1 mL of TFA was then added.

(3) The HPLC Conditions:

Column: C-18 reversed phase column

Eluent: 0.1% TFA/MeOH—H₂O (50:50, v/v)

Flow rate: 0.5 mL/min

Column temperature: 25° C.

Wavelength of UV detection: 210 nm

(4) Calculation of Raw Material Purity:
Purity (%) of TRODAT-1=(A_{TRODAT-1}/Aₜₒₜₐₗ)×100%

A_{TRODAT-1}: Peak area of TRODAT-1;

Aₜₒₜₐₗ: Total peak areas in the chromatogram

(5) Resolution of Chromatogram
R=[(t_{R2}−t_{R1})/(W_{half2}+W_{half1})]33 1.18

t_{R2} and t_{R1} are the respective retention time of the two neighboring peaks;

w_{half2} and w_{half1} are the respective half height width of the two neighboring peaks.

### BRIEF DESCRIPTION OF THE DRAWINGS

FIG. 1 illustrates HPLC chromatogram of TRODAT-1 raw material.

FIG. 2 illustrates parent ion mass spectrum (a) and product ion mass spectrum (b) of TRODAT-1.

FIG. 3 illustrates proposed chemical structures and molecular weight of the parent and product of TRODAT-1 in the mass spectra: (a) molecular formula=C₂₁H₃₄ClN₃S₂, molecular weight=428.10; (b) molecular formula=C₁₅H₂₀ClN, molecular weight=249.78.

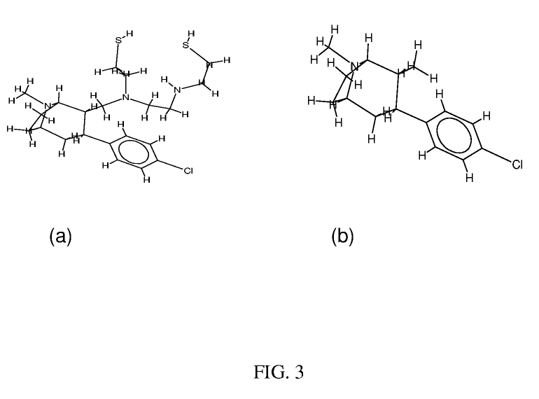

FIG. 4 illustrates HPLC chromatograms of HCl forced degradation test showing (a) before degraded reaction, (b) reaction achieved at 120 min and (c) relationship between peak areas and reaction time.

FIG. 5 illustrates HPLC chromatograms of NaOH forced degradation test showing (a) before degraded reaction, (b) reaction achieved at 210 min and (c) relationship between peak areas and reaction time.

### DETAILED DESCRIPTION OF THE PREFERRED EMBODIMENTS

### EXAMPLE 1

### HPLC Analysis and LC-MS/MS Method Validation

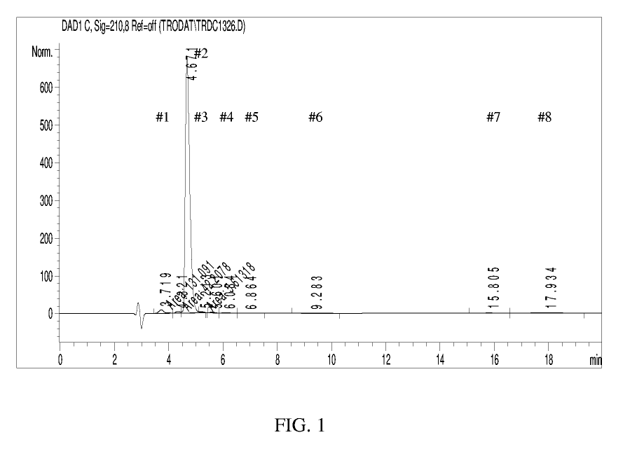

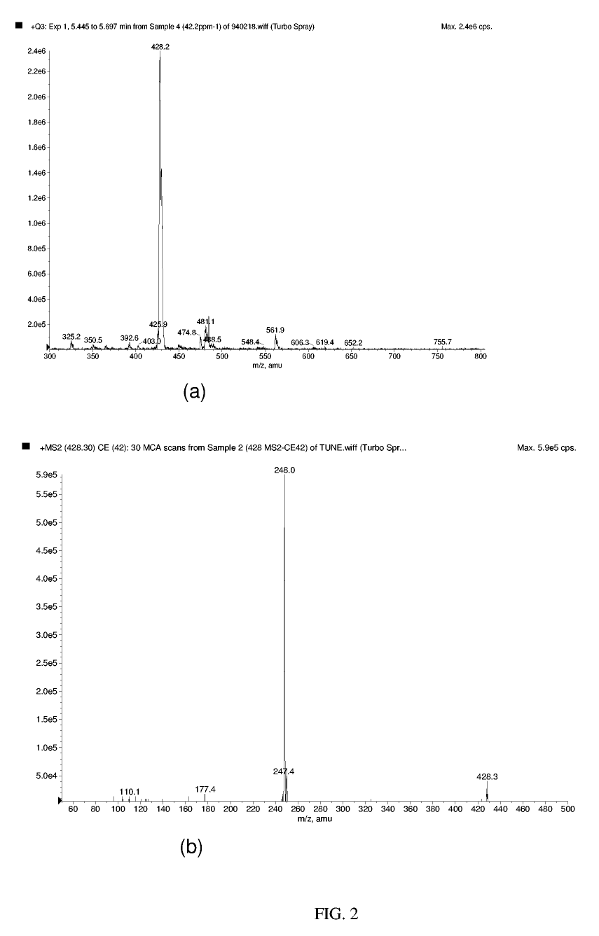

Analysis results of TRODAT-1 raw material by HPLC are shown in FIG. 1. The component of peak at retention time of 4.607±0.053 min as well as purity of 96.00±0.23% (Table 1) was confirmed to be TRODAT-1 through results of parent ion scan and product ion scan by LC-MS/MS (FIG. 2), indicated the m/z of parent ion was 428 and the m/z of product ion was 248. The proposed relevant chemical structures are shown in 3.a and 3.b.

TABLE 1
HPLC results for TRODAT-1 raw material

| | Retention time | Correlation | |
|---|---|---|---|
| Peak no. | (min)^{a} | coefficient^{b} | Peak area % |
| #1 | 3.697 ± 0.026 | 0.9796 | 1.43 ± 0.24 |
| #2 | 4.607 ± 0.053 | 0.9999 | 96.00 ± 0.23 |
| #3 | 5.579 ± 0.029 | 0.9988 | 0.25 ± 0.01 |
| #4 | 6.059 ± 0.027 | 0.9991 | 0.38 ± 0.05 |
| #5 | 6.821 ± 0.026 | 0.9970 | 0.25 ± 0.01 |
| #6 | 9.153 ± 0.087 | 0.9998 | 0.18 ± 0.03 |
| #7 | 15.466 ± 0.165 | 0.9996 | 0.43 ± 0.02 |
| #8 | 17.465 ± 0.294 | 0.9997 | 1.08 ± 0.03 |

^{a}Average retention time for n = 9
^{b}Correlation curves in the injection volume range of 1˜5 μL, n = 3

### EXAMPLE 2

### Demonstration for the Specificity of HPLC Assay Method

Forced degradation tests were performed for TRODAT-1 raw material in order to demonstrate the specificity of the proposed HPLC assay method. Intentional degradations were attempted to stress conditions, i.e., acid hydrolysis and base hydrolysis to evaluate the ability of the analytical method to separate TRODAT-1 from its degradation products and determine the quantities accurately.

The tests were carried out by exposure of TRODAT-1 in 0.01 M HCl or 0.01 M NaOH before applying HPLC assay. The results of HPLC were then used to calculate the resolutions between degradation products and TRODAT-1.

(1) Forced Degradation Test by 0.01 M HCl

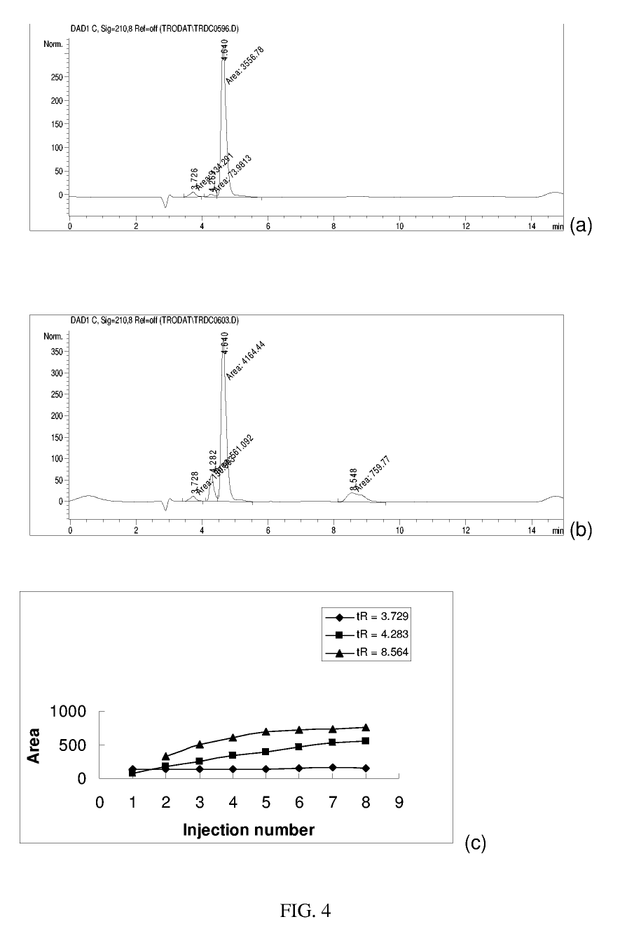

Verification results (FIG. 4) showed that the retention time (t_{R}) of TRODAT-1 was 4.60 min, after addition of 0.01 M HCl, two peaks formed immediately in the retention time (t_{R}) of 4.28 min and 8.56 min. The original absorption of peak at 4.60 min was gradually reduced and reached stable state around 120 min. At this point, the resolutions between peak of TRODAT-1 and peaks of the degradation products were 1.41 and 6.26, and the purity of TRODAT-1 was decreased from 95% to 74%. This result of clear HPLC resolutions between TRODAT-1 and degradation products can be used to confirm the specificity of proposed HPLC assay method.

(2) Forced Degradation Test by 0.01 M NaOH

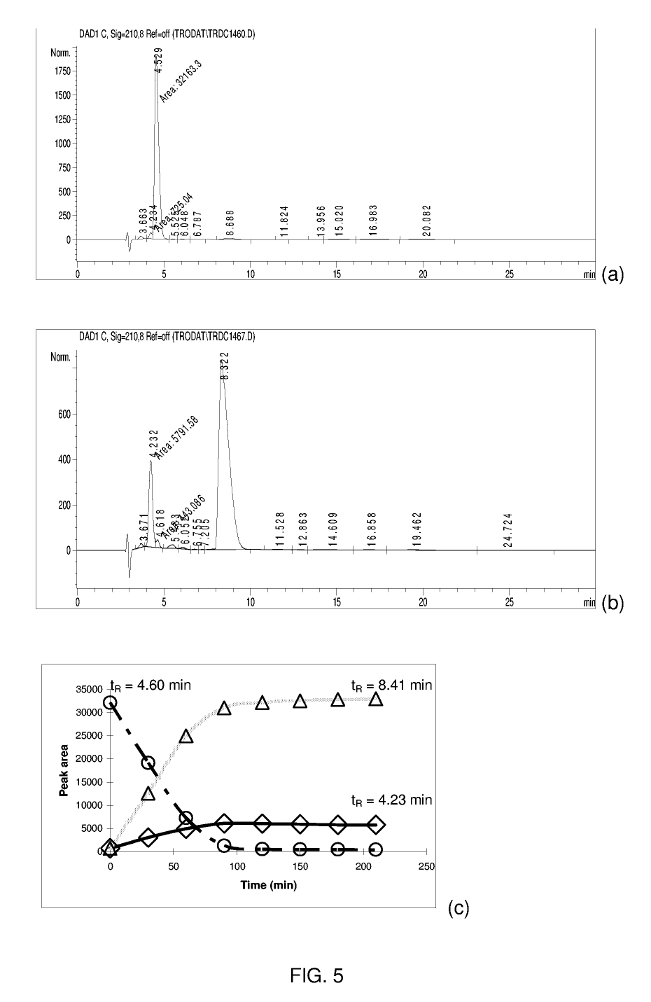

Verification results (FIG. 5) showed that the retention time (t_{R}) of TRODAT-1 was 4.60 min, after addition of 0.01 M NaOH, two peaks formed immediately in the retention time (t_{R}) of 4.23 min and 8.41 min. The original absorption of peak at 4.60 min was gradually reduced and reached stable state around 100 min. At reaction time of 210 min, resolutions between peak of TRODAT-1 and peaks of the degradation products were 0.974 and 5.423. The peak area of TRODAT-1 was reduced to 1.38% of the original content, and the areas of both peaks at 4.23 min and 8.41 min were increased to 800% and 4500% compare to initial content, respectively. This result of clear HPLC resolutions between TRODAT-1 and degradation products can be used to confirm the specificity of proposed HPLC assay method.

The above two examples are the better examples to describe this present invention, an analytical method for the purity assay of TRODAT-1 raw material. For those who have already familiar with this skill can still consult the explanation of this invention, make modification or change and get the same results. The modification and change should still be within the scope of this invention. The invention should not be interpreted as confined to the specific form and examples as displayed and described; instead it is set forth to the following claims.

What is claimed is:

1. An assay method for the purity assay of TRODAT-1 raw material includes utilization high performance liquid chromatography (HPLC), liquid chromatography tandem mass spectrometry (LC-MS/MS), HPLC column, preparation of samples, regents and eluent as well as performing parent and product ions scan by mass spectrometry for the method validation, calculation of chromatographic resolutions and raw material purity, wherein:
1) The HPLC consisted of a pump, a degasser, an injector, an autosampler, a thermostated column compartment, and a variable wavelength detector (VWD) or a photo-diode array detector (DAD);
2) The HPLC conditions are as follows:
Column: C-18 reverse phase column;
Eluent: 0.1% TFA/MeOH—H₂O (50:50, v/v);
Flow rate: 0.5 mL/min;
Column temperature: 25° C.;
Wavelength of UV detection: 210 nm;
3) Reagents: methanol and trifluoroacetic acid (TFA)
4) Preparation of the standard and sample solutions: TRODAT-1 was dissolved in methanol to an appropriate concentration;
5) Preparation of eluent: TFA was added to the mixture of methanol and de-ionized water;
6) Calculation of raw material purity:
Purity (%) of TRODAT-1=(A_{TRODAT-1}/Aₜₒₜₐₗ)×100%
A_{TRODAT-1}: Peak area of TRODAT-1;
Aₜₐₜₐₗ: Total peak areas in the chromatogram;
7) Calculation of HPLC resolution:
R=[(t_{R2}−t_{R1})/(W_{half2}+W_{half1})]×1.18;
t_{R2} and t_{R1}, are the respective retention time of the two neighboring peaks;
w_{half2} and w_{half1} are the respective half height width of the two neighboring peaks.

2. The assay method as claim 1, wherein the TRODAT-1 raw materials include TRODAT-1 and relevant derivatives of tropane.

3. The assay method as requested of claim 1, wherein the HPLC column includes various reverse phase columns and do not subjected to the C-18 column this invention specified.

4. The assay method as claim 1, wherein the TFA concentration of eluent is in the range of 0.1% to 0.5% in dissolution of MeOH—H₂O mixture from ratio of 40:60 to 60:40 (v/v).

5. The assay method as claim 1, wherein the flow rate of eluent is in the range of 0.5˜1.0 mL/min.

6. The assay method as claim 1, wherein the wavelength of UV detection is in the range of 210 nm˜250 nm.

7. The assay method as claim 1, wherein the proposed method can be validated by forced degradation tests. TRODAT-1 is exposed to acid (i.e., HCl, HNO₃) or base (i.e., NaOH, KOH) of external stress conditions for forced degradation, follows by analyzing with HPLC and calculates the chromatographic resolutions between degradation products and TRODAT-1 to ensure the specificity of analytical method.
